(19) United States
(12) Patent Application Publication
(10) Pub. No.: US 2003/0197720 A1
(43) Pub. Date: Oct. 23, 2003

(54) System and method for providing object-based video service

(75) Inventors: Young-Su Moon, Seoul (KR); Chang-Yeong Kim, Kyungki-do (KR); Ji-Yeun Kim, Seoul (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/402,998

(22) Filed: Apr. 1, 2003

(30) Foreign Application Priority Data
Apr. 17, 2002 (KR) 2002-20915

(51) Int. Cl. G09G 5/00

(52) U.S. Cl. 345/716

(57) ABSTRACT

A system and method for providing object-based video services are provided. The system for providing object-based video services comprises an interactive video authoring unit which tracks an object of interest for each frame of input moving pictures with using a predetermined object tracking algorithm, generates an object tracking scenario, and links each object to additional information; a service server which stores the moving pictures, the object tracking scenario, and additional information linked to each object, and if a service is requested through a communications network, provides the object tracking algorithm, the stored moving pictures, the object tracking scenario, and the additional information; and a client unit which receives the object tracking algorithm from the service server through the communications network and installs the algorithm, and if the moving pictures, the object tracking scenario, and the additional information are provided, generates an object label image corresponding to each frame of the moving pictures according to the object tracking scenario by using the installed object tracking algorithm, extracts additional information corresponding to an object selected by a user based on the generated object label image, and displays the additional information. Accordingly, since the service server stores only tracking scenario data taking up relatively less memory than object label images, memory use in the service server can be greatly reduced. Also, since the service server transmits only tracking scenario data whose amount is very small, transmission efficiency can increase while transmission error and data distortion can be minimized.

### BACKGROUND OF THE INVENTION

This application claims the priority of Korean Patent Application No. 2002-20915, filed on Apr. 17, 2002 in the Korean Intellectual Property Office, which is incorporated herein in its entirety by reference.

1. Field of the Invention

The present invention relates to a video service system, and more particularly, to a video service system and method for providing object-based interactive additional information services.

2. Description of the Related Art

In general, in order to provide object-based interactive additional information services for moving pictures such as movies, TV programs, and commercial films, service providers should make sequences of object label images containing image area information on objects of interest in moving pictures in advance, using predetermined video authoring tools and store the object label sequences along with the original moving pictures in DBs. More specifically, the video authoring tool extracts continuously the areas (or regions) of objects of interest in moving pictures by using a predetermined object tracking algorithm in an offline mode, forms a sequence of object label images. In each object label image the individual object area (or region) is represented by a different gray value, and the object label sequence is stored in the DB. If a service user requests an interactive video service, the service provider transmits moving pictures prepared in advance in the DB, the corresponding object label images, and additional information linked to each object. The object label images are first encoded and then transmitted to increase transmission efficiency. Watching moving pictures on a reproducing display apparatus, the service user selects provided objects by using mouse or other input devices to check additional information linked to each object.

FIG. 1 is a block diagram of the structure of the prior art object-based interactive video service system which comprises an interactive video authoring unit 100, a service server 200, and a client unit 300.

Referring to FIG. 1, in the interactive video authoring unit 100, a video reproducing unit 110 reproduces or checks input moving pictures, and a video editing unit 120 edits moving pictures that are desired to be served among the input moving pictures. An object extracting unit 130 extracts the object areas of each interest object in the edited moving pictures, and an object labeling unit 140 forms an object label image sequence by composing the object areas individually extracted in each frame into a corresponding object label image and by repeating it for all frames. An object link unit 150 links additional information related to each object to the object areas.

In the service server 200, a video frame DB 210 stores original video frames, and an object label DB 220 stores corresponding object label image sequences generated in the object labeling unit 140 of the interactive video authoring unit 100. Also, an additional information DB 230 stores additional information linked to each object of object label images in the object link unit 150. The service server 200 transmits the requested original video frames, the related object label sequence and its additional information stored in DBs 210 through 230 to the client unit 300 through a communications network.

The client unit 300 stores the original moving picture frames, object label information sequence, and linked additional information provided by the service server 200, in respective memories 310 through 330. The client unit 300 reproduces moving pictures stored in the memory 310 on the screen of an interactive video reproducing unit 340 by using the reproducing unit 340, and if the service user selects an object on the screen of the reproducing unit 340 by using an input means such as a mouse, recognizes the selected object through an object label image of the corresponding frame. The client unit 300 finds the information linked to the selected object from the memory 330 and provides it to the user.

FIG. 2 is a schematic diagram showing a process providing additional information on a selected object, the process which is performed in a client unit 300 shown in FIG. 1.

Referring to FIGS. 1 and 2, while moving pictures stored in the frame memory 310 are reproduced through the interactive video reproducing unit 340, the user can select desired objects on the screen 342, by using the mouse. The interactive video reproducing unit 340 refers to a corresponding object label image stored in the object memory 320, find an object label corresponding to the pixel, on which the mouse cursor is currently placed and clicked, in step 344. Then, additional information linked to the object (label) selected by referring to the link information memory 330 is extracted in step 346, and the extracted result is displayed on the screen in step 348. If the extracted additional information is a web page providing information on the selected object, the corresponding web page is displayed on the screen 350 as shown in FIG. 2.

As described above, in the prior art object-based interactive video service system, an object label image is generated for each video frame, storage space 220 for storing these object label image sequences is needed. Furthermore, object area (or location) information may suffer significant loss or distortion in the processes of encoding, transmitting, and decoding the object label images. When network transmission capacity is small or traffic loads are too heavy between the service server 200 and the client unit 300, data distortions occur in transmission such that serious quality problems rise in object information. Particularly when object label images are distorted by transmission error, object-based additional information service itself may not operate. In order to reduce this storage and transmission problems, there is a method in which geometrical descriptors that can roughly express object location or areas (for example, rectangles, circles, or polygons) are used in storage and transmission (Refer to U.S. Pat. No. 6,144,972). Although this method may partially solve the storage and transmission problems, but accurate shape or location information in units of pixels on an object of interest cannot be provided and so it is difficult to provide high quality object-based interactive service.

### SUMMARY OF THE INVENTION

The present invention provides an object-based video service system and method in which the amount of transmission data is minimized so that transmission error and distortion can be minimized.

The present invention also provides a computer readable medium having embodied thereon a computer program for the object-based video service method.

The present invention further provides an interactive video reproducing apparatus and method in which using an object tracking algorithm, which may be installed first one time along with an interactive video reproducing unit in the client part, an object label image corresponding to a video frame being currently reproduced is generated in real time.

The present invention further provides a computer readable medium having embodied thereon a computer program for the interactive video reproducing method.

According to an aspect of the present invention, there is provided an object-based video service system comprising an interactive video authoring unit which tracks an object of interest for each frame of input moving pictures with using a predetermined object tracking algorithm, generates a corresponding object tracking scenario, and links each object to additional information; a service server which stores the moving pictures, the object tracking scenario, and additional information linked to each object, and if a service is requested through a communications network, provides the object tracking algorithm, the stored moving pictures, the object tracking scenario, and the additional information; and a client unit which receives the object tracking algorithm from the service server through the communications network and installs the algorithm whenever the upgrading of the tracking algorithms occurs, and if the moving pictures, the object tracking scenario, and the additional information are provided, generates an object label image corresponding to each frame of the moving pictures according to the object tracking scenario by using the installed object tracking algorithm, extracts additional information corresponding to an object selected by a user based on the generated object label image, and displays the additional information.

According to another aspect of the present invention, there is provided an object-based video service method in which object-based interactive moving pictures are provided to a client unit belonging to a user, the method comprising (a) tracking an object of interest in each frame of the moving pictures according to a predetermined object tracking algorithm, while generating and storing an object tracking scenario; (b) linking additional information to be provided for each object, and storing the additional information; (c) if a request of providing the moving picture from the client unit is received, providing object-based video data, including the moving pictures, the object tracking scenario, and the additional information; (d) the client unit generating in real time an object label image corresponding to each frame of the moving pictures according to the object tracking scenario with using the object tracking algorithm; and (e) based on the generated object label image, displaying additional information corresponding to an object selected by the user.

According to still another aspect of the present invention, there is provided an interactive video apparatus comprising a memory unit which receives moving pictures and additional information linked to each object that are transmitted through a communications network, and stores the moving pictures and additional information; an object tracking unit which if an object tracking scenario is transmitted through the communications network, drives a predetermined object tracking algorithm, generates in real time an object label image for each frame according to the object tracking scenario, and stores the generated object label image for each frame in the memory unit; and an interactive video reproducing unit which reproduces the moving pictures stored in the memory unit, and referring to the object label image for each frame, recognizes an object selected by a user, extracts additional information on the recognized object from the memory unit, and provides the additional information.

According to yet still another aspect of the present invention, there is provided an object-based video reproducing method in which object-based moving pictures are displayed on a display unit interfacing with a user, the method comprising (a) receiving moving pictures, an object tracking scenario on an object tracking process, and additional information linked to each object, from the outside, and storing the data in a memory; (b) generating in real time an object label image corresponding to each frame of the moving pictures according to the object tracking scenario, by using an object tracking algorithm, and storing the images; (c) reproducing the stored moving pictures, and recognizing an object selected by the user by referring to an object label image corresponding to each frame; and (d) extracting additional information linked to the recognized object from the memory and providing the additional information.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of the structure of the prior art object-based interactive video service system;

FIG. 2 is a schematic diagram showing a process providing additional information on a selected object which is performed in a client unit 300 shown in FIG. 1;

FIG. 3 is a schematic block diagram showing an object-based video service system according to the present invention;

FIG. 4 shows a preferred embodiment of an object tracking process performed in an object tracking unit shown in FIG. 3;

FIGS. 5(a) through (d) show examples of tracking scenarios which are generated as a result of object tracking shown in FIG. 4;

FIG. 6 is a flowchart showing a preferred embodiment of a video reproducing method performed in a client unit shown in FIG. 3;

FIG. 7 is a flowchart showing step 910 of the flowchart of FIG. 6;

FIG. 8 is a diagram for explaining the operation of the client unit when new object tracking scenario data due to the occurrence of an object tracking event are transmitted together; and

FIG. 9 is a diagram for explaining the operation of the client unit when event does not occur or when a user selects an object.

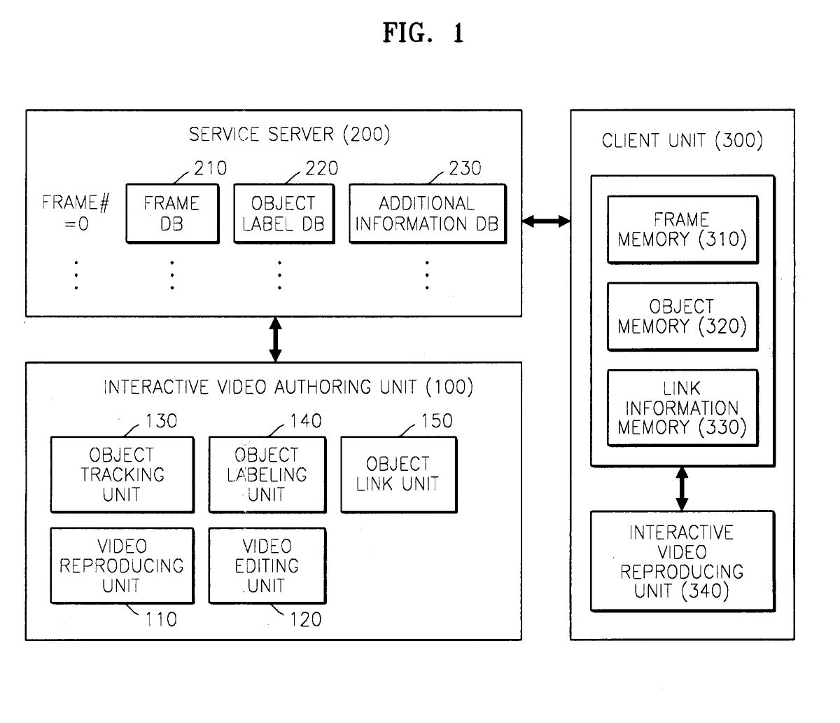

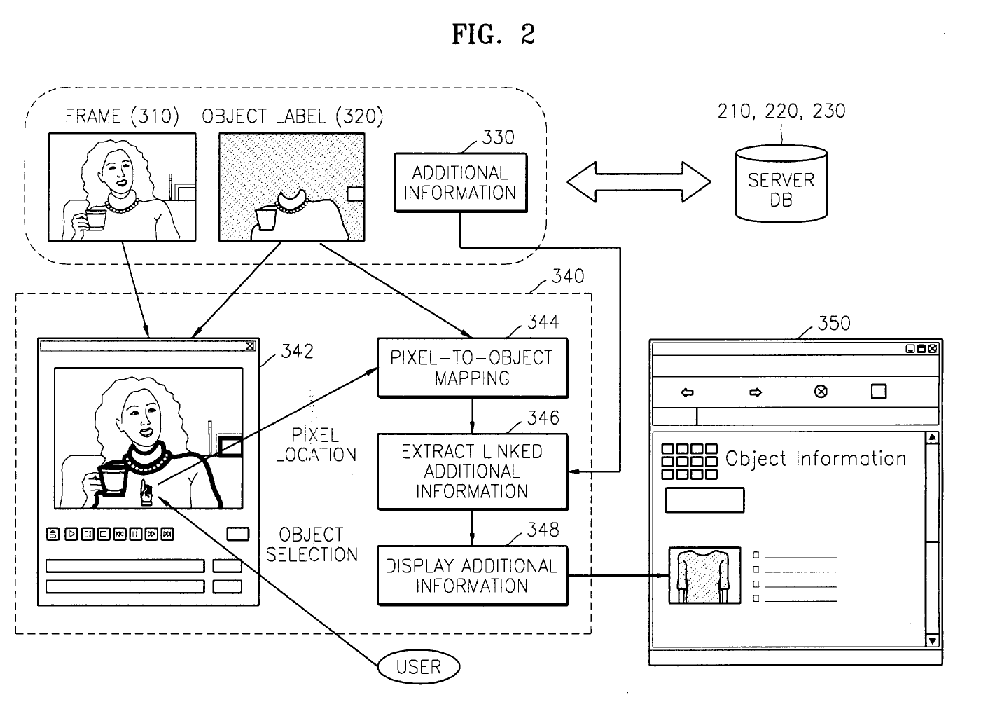

### DESCRIPTION OF THE PREFERRED EMBODIMENTS

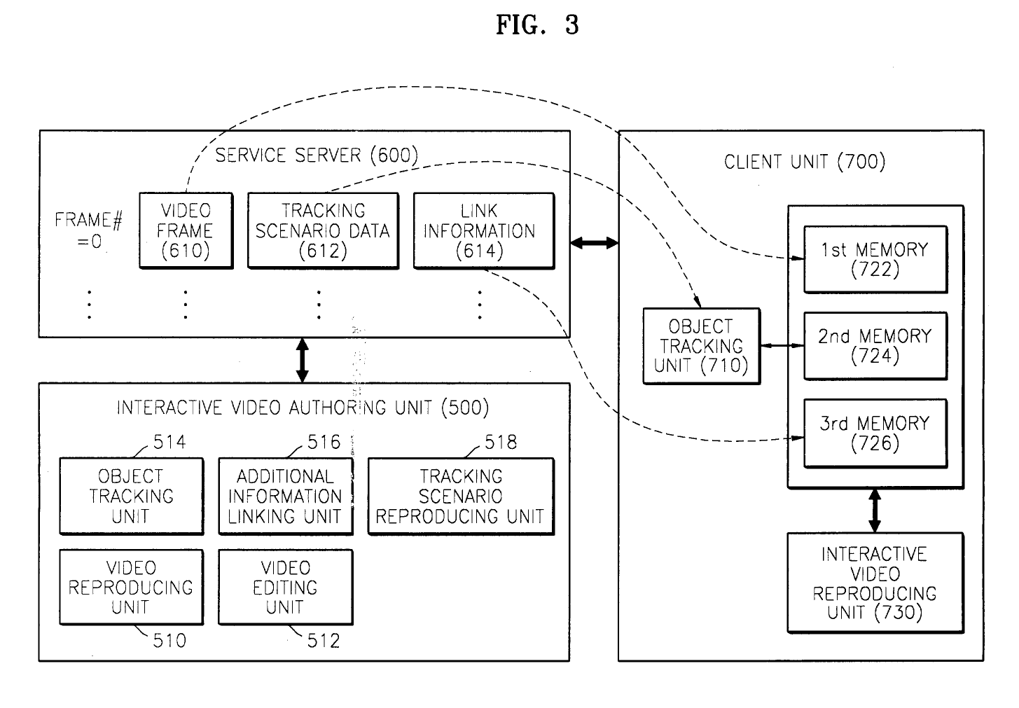

FIG. 3 is a schematic block diagram showing an object-based video service system according to the present invention, the system comprises an interactive video authoring unit 500, a service server 600, and a client unit 700.

Referring to FIG. 3, the video authoring unit 500 tracks an object area for each frame of input moving pictures by using a predetermined object tracking algorithm, generates an object tracking scenario in which a process tracking an object is recorded, and links additional information to be provided for each object. More specifically, the video authoring unit 500 comprises a video reproducing unit 510, a video editing unit 512, an object tracking unit 514, an object link unit 516, and a tracking scenario generating unit 518.

The video reproducing unit 510 reproduces and checks input moving pictures, and the video editing unit 512 edits moving pictures desired to be provided among the input moving pictures.

The object tracking unit 514 first assigns a tracking interval for each interest object in the moving pictures edited in the video editing unit 120 and selects an object area to be tracked in the initial frame. Assuming that the predetermined object tracking algorithm includes a plurality of object tracking methods that are mutually complementary, an appropriate object tracking method among the methods is selected, and an initial job setting parameters needed in performing the selected object tracking method is executed. Then, using the initially set object tracking method and the parameters, the interest object is tracked in the set frame tracking interval. If the object tracking fails in the middle, the object tracking stops, and an object area is again assigned in the frame for which the object tracking failed, and an appropriate object tracking method and parameters are set again. Thus, object tracking begins from the frame for which the object tracking failed, with the reset object tracking conditions and this processes are repeatedly performed all objects of interest. Also, this series of object tracking processes, for example, the object area, the object tracking method, and parameters that are initially set, and the object area, the object tracking method, and parameters that are rest in the frame for which object tracking failed, are stored.

The tracking scenario generating unit 518 generates an object tracking scenario based on tracking information (for example, the initial object area, the tracking method used in the object tracking, parameters, tracking frame intervals, etc.) for each object generated/stored in the object tracking unit 514. This scenario is generated sequentially for frames, for which a new object tracking begins, or an object tracking with new conditions resumes after an object tracking job in progress fails, that is, for tracking event frames. Data contained in this object tracking scenario include information on an object whose tracking begins in the corresponding event frame, an object tracking frame interval for each object, an object tracking method and set parameters for each object, and an object area which is initially set. Here, the tracking scenario generating unit 518 generates together one object label image in which the initial area of each object desired to be tracked is expressed in a different gray value in an event frame.

The additional information link unit 516 links information desired to be provided for each object as additional information, to each object. For example, the additional information may be product information or web page information on an object.

Next, the service server 600 receives and stores the object tracking scenario generated in the video authoring unit 500, additional information linked to each object, and moving pictures. In the service server 600 as shown in FIG. 3, moving pictures are stored in units of frames in a first database 610, object tracking scenarios are stored in a second database 612, and additional information linked to each object is stored in a third database 614. If the service server 600 receives a request for object-based video service from the client unit 700, the service server 600 transmits moving pictures, object tracking scenarios, and linked additional information, as object-based video data, to the client unit 700. Here, in transmitting object-based video data stored in the service server 600, the service server 600 may transmit all the video data at once or may transmit the video data in units of frames.

If the object tracking algorithm, moving pictures, object tracking scenarios, and additional information are provided from the service server 600 through a communications network, the client unit 700 tracks the area of each object according to object tracking scenarios using the object tracking algorithm, and generates an object label image corresponding to each frame of moving pictures in real time. Here, once the object tracking algorithm is provided and installed in the client unit 700, it is not needed to receive the object tracking algorithm from that time any more. Only when update of the object tracking algorithm is needed, the client unit 700 can request the service server 600 to provide an object tracking algorithm. If the user selects an object while moving pictures are reproduced, the client unit 700 recognizes the label of the selected object based on the object label image. Then, the client unit 700 extracts additional information corresponding to the recognized object label, and provide the information to the user. More specifically, the client unit 700 comprises an object tracking unit 710, a memory unit 720, and an interactive video reproducing unit 730.

The object tracking unit 710 receives the object tracking algorithm and tracking scenario data transmitted by the service server 600, drives the same number of object tracking algorithms as the number of objects desired to be tracked, and performs object tracking according to the tracking scenario data for each object in real time. With tracking an object area for each object, the object tracking unit 710 generates an object label image corresponding to each frame, the image in which each object is labeled by a predetermined gray value, and stores the image in the memory unit 720.

The memory unit 720 comprises a first through a third memories 722 through 726. Moving pictures and additional information transmitted by the service server 600 are stored in the first memory 722 and the third memory 726, respectively, and the object label image generated in the object tracking unit 710 is stored in the second memory 724.

The interactive video reproducing unit 730 reproduces moving pictures stored in the first memory 722, and if the user selects a predetermined object during the reproduction of moving pictures, recognizes the object selected by the use, by referring to an object label image of the corresponding frame. Then, the interactive video reproducing unit 730 extracts additional information linked to the recognized object from the third memory 726 and provides the additional information to the user.

Meanwhile, if the service server 600 transmits object-based video data to the client unit 700 at a time, the client unit 700 receives and stores the transmitted object-based video data for the moment. If the receiving of the object-based video data is completed, the stored moving pictures are reproduced and the object tracking unit 710 applies the received tracking scenario to the object tracking algorithm to generate object label images corresponding to video frames being reproduced in real time. If the service server 600 transmits video data in units of frames to the client unit 700, the client unit 700 receives the video data transmitted in units of frames, stores the video data in the memory unit 720, while reproduces the video data through the interactive video reproducing unit 730. The object tracking unit 710 generates object label images corresponding to the received frames in real time and stores the object label images in the memory unit 720. Thus, when object-based video data are transmitted in units of frames, the service server 600 does not need to transmit tracking scenario data and linked additional information for each frame. That is, in transmitting tracking scenario data, if object tracking fails or a new object appears in an event frame, tracking scenario data to be applied to the event frame in which object tracking fails or a new object appears are transmitted from the event frame. Also, in transmitting linked additional information, if a new object appears in an event frame, additional information linked to the object is transmitted from the event frame.

As described above, the video authoring unit 500 generates tracking scenario data that are for tracking processes of object areas, instead of generating object label images corresponding to respective frames. Accordingly, the service server 600 stores tracking scenario data instead of storing object label images corresponding to respective frames such that memory use in the service server can be greatly reduced. Also, the service server 600 transmits only tracking scenario data and does not need to transmit object label images corresponding to respective frames, transmission error and data distortion can be minimized.

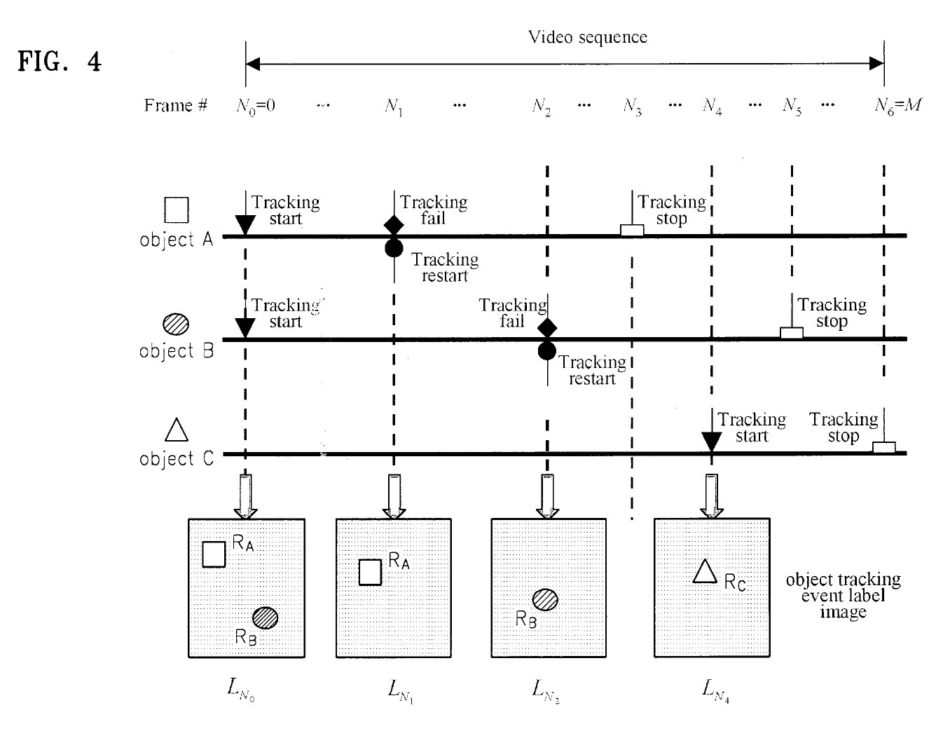

FIG. 4 shows a preferred embodiment of an object tracking process performed in the object tracking unit 514 shown in FIG. 3.

Referring to FIG. 4, first, for a square object A, initial area R_{A} is set in frame N₀, and in a predetermined object tracking algorithm an object tracking method and related parameters desired to be used in object tracking are set. For convenience of explanation, it is assumed that 3 mutually complementary object tracking methods are included in the predetermined object tracking algorithm, object tracking method “1” is used for tracking object A, and the related parameter is Pₐ. While tracking object A is performed under these conditions, if tracking fails in frame N₁, area R_{A} for object A is set again, method “3” is used as a new object tracking method, and related parameter Pₐ′ is set as shown in FIG. 4. From frame N₁, newly set object tracking method and parameter are applied to track object A, continue to frame No, and tracking object A is completed.

If tracking object A is completed, for a circle-shaped object B, initial area R_{A} is set in frame N₀, and an object tracking method and related parameters are set. For convenience of explanation, it is assumed that object tracking method “2” is used for tracking object B, and the related parameter is Pb. While tracking object B is performed under these conditions, if tracking fails in frame N₂, area R_{B} for object B is set again, method “1” is used as a new object tracking method, and related parameter P_{b}′ is set as shown in FIG. 4. From frame N₂, newly set object tracking method and parameter are applied to track object B, continue to frame N₅, and tracking object B is completed.

If tracking object B is completed, for a triangle-shaped object C, initial area R_{C} is set in frame N₄, and an object tracking method and related parameters are set. For convenience of explanation, it is assumed that object tracking method “1” is used for tracking object C, and the related parameter is Pc. While tracking object C is performed under these conditions, if tracking object C does not fail, the same conditions are applied to frame N₆ and then tracking object C is completed.

Accordingly, for tracking object A, method “1” and parameter Pa are applied from frame No to frame N₁−1, and method “3” and parameter Pₐ′ are applied from frame N₁ to frame N₃. For tracking object B, method “2” and parameter P_{b} are applied from frame N₁ to frame N₂−1, and method “1” and parameter P_{b}′ are applied from frame N₂ to frame N₅. Also, for tracking object C, method “1” and parameter P_{c} are applied from frame N₄ to frame N₆.

As described above, it is shown that as a result of tracking three objects A, B, and C, four tracking event frames N₀, _{N}₁, N₂, and N₄ are generated and object tracking information, including object areas, object tracking methods and related parameters set in each tracking event frame, are stored. Also, generated and stored are object label images L_{N0}, L_{N1}, L_{N2}, and L_{N4}, as shown in FIG. 4, in which the object areas desired to be tracked in respective event frames are expressed in different gray values. The tracking scenario generating unit 518 shown in FIG. 3 generates object tracking scenarios, using object tracking information, including object areas, object tracking methods and related parameters, and object label images L_{N0}, L_{N1}, L_{N2}, and L_{N4}.

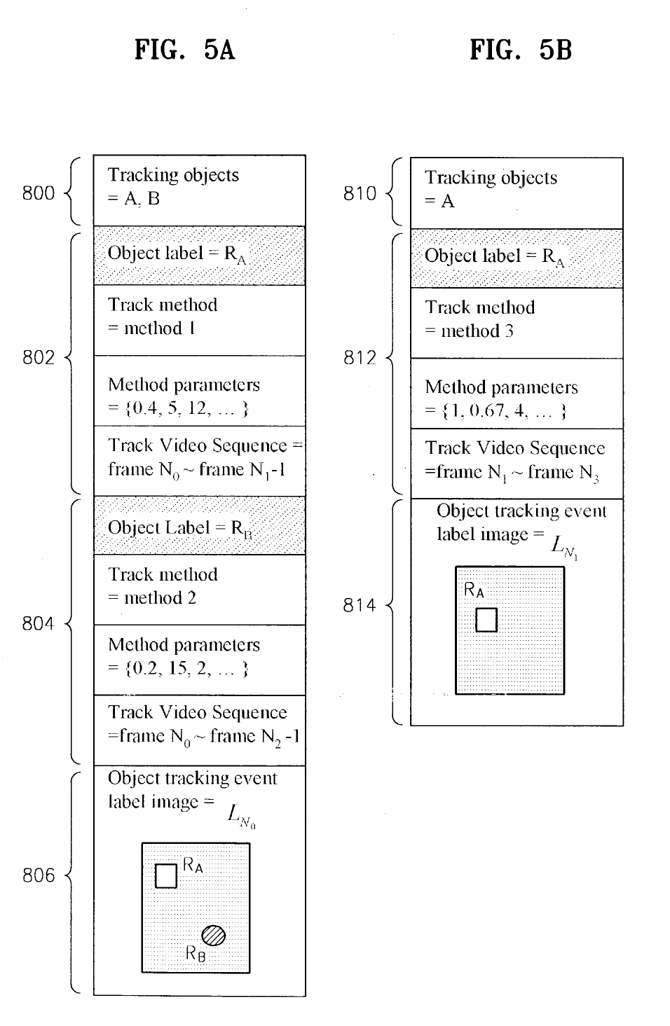

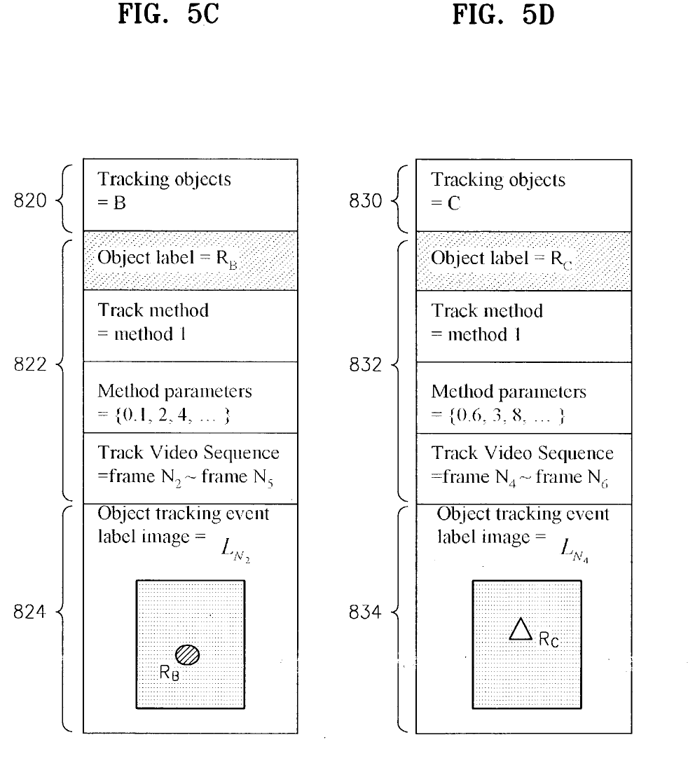

FIGS. 5(a) through (d) show examples of tracking scenarios which are generated as a result of object tracking shown in FIG. 4.

FIG. 5(a) is an object tracking scenario based on conditions set in the initial frame N₀ for object tracking. Referring to FIG. 5(a), in the tracking event frame N₀, condition 800 that tracking objects A and B are to begin is recorded. Conditions 802 for tracking object A that object label for object A is R_{A}, method “1” (method 1) is used for object tracking, applied parameter Pₐ={0.4, 5, 12, . . .}, frames in which object A is tracked under these conditions are frame N₀˜frame N₁−1 are recorded. Also, conditions 804 for tracking object B that object label for object A is R_{B}, method “2” (method 2) is used for object tracking, applied parameter P_{b}={0.2, 15, 2, . . .}, frames in which object B is tracked under these conditions are frame N₀˜frame N₂−1 are recorded. Also, object label image L_{NO} 806 in which the areas of objects A and B in the tracking event frame N₀ are expressed is stored together with the scenario of the tracking event frame N₀. This event object label image is transmitted to the client unit 700, and referring to this object label image, the object tracking unit 710 of the client unit 700 can perform tracking of each object area.

FIG. 5(b) is an object tracking scenario for frame N₁ in which new conditions for tracking object A are set after failure of tracking object A occurs in FIG. 4. First, condition 810 that the scenario shown in FIG. 5(b) is for tracking object A is recorded. Then, new conditions 812 for tracking object A that object label for object A is R_{A}, method “3” (method 3) is used for object tracking, applied parameter Pₐ′={0.4, 5, 12, . . .}, frames in which object A is tracked under these conditions are frame N₁˜frame N₃ are recorded. Also, event object label image L_{N1} 814 for event frame N₃ is recorded together.

FIG. 5(c) is an object tracking scenario for frame N₂ in which new conditions for tracking object B are set after an event of failure of tracking object B occurs in FIG. 4. Referring to FIG. 5(c), first, condition 820 that the scenario is for tracking object B is recorded. Then, new conditions 822 for tracking object B that object label for object B is R_{B}, method “1” (method 1) is used for object tracking, applied parameter P_{b}={0.1, 2, 4, . . .}, frames in which object B is tracked under these conditions are frame N₂˜frame N₅ are recorded. Also, event object label image L_{N2} 824 for event frame N₂ is recorded together.

FIG. 5(d) is an object tracking scenario for tracking object C in frame N₄ in which a new object C appears. Referring to FIG. 5(d), first, condition 830 that the scenario is for tracking object C is recorded. Then, new conditions 832 for tracking object C that object label for object C is R_{C}, method “1” (method 1) is used for object tracking, applied parameter P_{c}={0.6, 3, 8, . . .}, frames in which object C is tracked under these conditions are frame N₄˜frame N₆ are recorded. Also, event object label image L_{N4} 834 for event frame N₄ is recorded together.

Meanwhile, if there is a request from the user, the tracking scenario data for respective objects shown in FIGS. 5(a) through 5(d) are transmitted to the client unit 700 through the service server 600. At this time, all scenario data may be transmitted at a time, or in units of frames. If the data are transmitted in units of frames, the service server 600 transmits tracking scenario data for tracking objects A and B (Refer to FIG. 5(a)) and additional information linked to objects A and B to the client unit 700 when the service server 600 transmits frame N₀. From that time, only frame data are transmitted, and when frame N1 is transmitted, tracking scenario data for tracking object A (Refer to FIG. 5(b)) are transmitted. Also, only frame data are transmitted from frame N₁+1 to frame N₂−1, and when frame N₂ is transmitted, tracking scenario data for tracking object B (Refer to FIG. 5(c)) is transmitted. Then, only frame data are transmitted from frame N₂+1 to frame N₄−1, and when frame N₄ is transmitted, tracking scenario data for tracking object C (Refer to FIG. 5(d)) and additional information linked to object C are transmitted together.

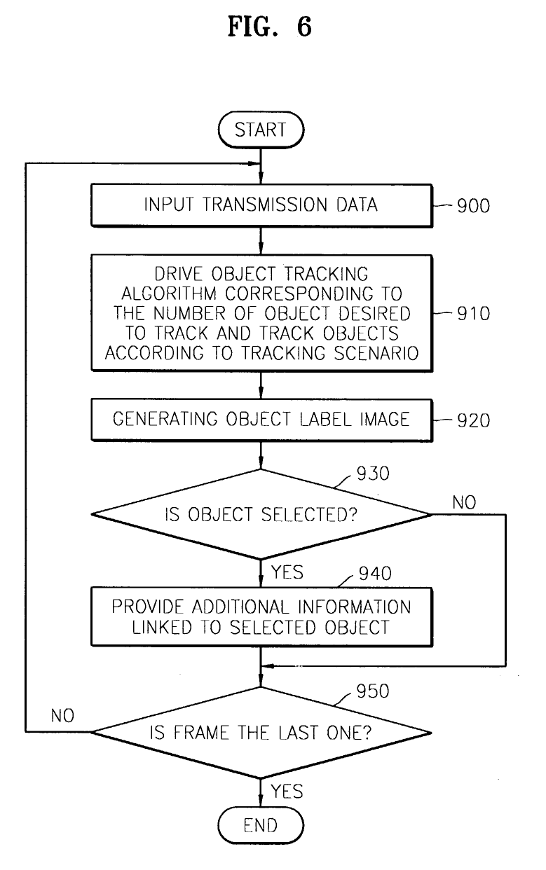

FIG. 6 is a flowchart showing a preferred embodiment of a video reproducing method performed in the client unit 700 shown in FIG. 3. For convenience of explanation, it is assumed that in the video reproducing method shown in FIG. 6 the client unit 700 receives video frame to be reproduced, tracking scenario data, and lined additional information at every video frame time from the service server 600.

Referring to FIGS. 3 and 6, the client unit 700 receives object-based video data, that is, moving pictures, tracking scenario data, and additional information, transmitted in units of frames from the service server 600 and stores the data in the memory unit 720 in step 900. The interactive video reproducing unit 730 reproduces moving pictures received in units of frames through its interactive video reproducing device. At this time, the object tracking unit 710 drives the same number of received object tracking algorithms as the number of objects desired to be tracked and tracks objects according to the tracking scenario data for respective objects in step 910. The object tracking unit 710 generates an object label image for a frame currently being reproduced, in real time in step 920. Then, the generated object label image is stored in the memory unit 720.

While performing video reproducing and object label image generating, the interactive video reproducing unit 730 determines whether or not the user selects a predetermined object using an input device such as a mouse in step 930. If the user selects one object included in a predetermined frame through the interactive video reproducing unit 730, the label of the selected object is recognized based on the object label image of the corresponding frame generated and stored in step 920. Then, linked additional information corresponding to the recognized object label is extracted from the memory unit 720 and provided to the user in step 940. This process is repeated until the last frame is reproduced, and if reproducing the last frame is completed, the video reproducing is finished in step 950.

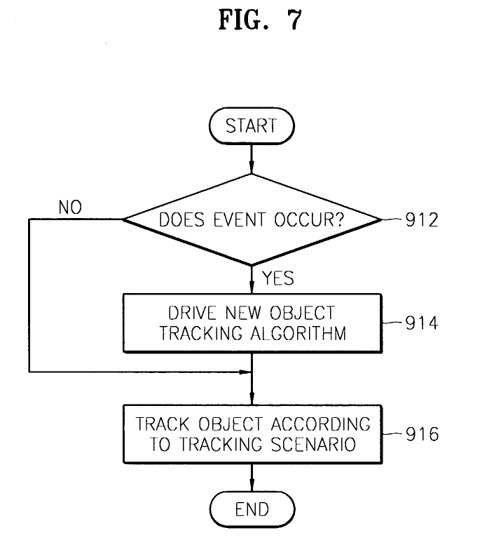

FIG. 7 is a flowchart showing step 910 of the flowchart of FIG. 6.

Referring to FIGS. 3 and 7, the object tracking unit 710 determines whether or not new tracking scenario data due to an event occurrence is transmitted together when a frame currently being input is transmitted, in step 912. If there is no new tracking scenario data, the object tracking unit 710 continues object tracking according to the tracking scenario previously received, in step 916. However, if new tracking scenario data for tracking a predetermined object are received in step 912, the object tracking unit 710 drives an object tracking algorithm for tracking object according to a new tracking scenario in step 914. Then, according to the provided tracking scenario, tracking for each object is performed in step 916.

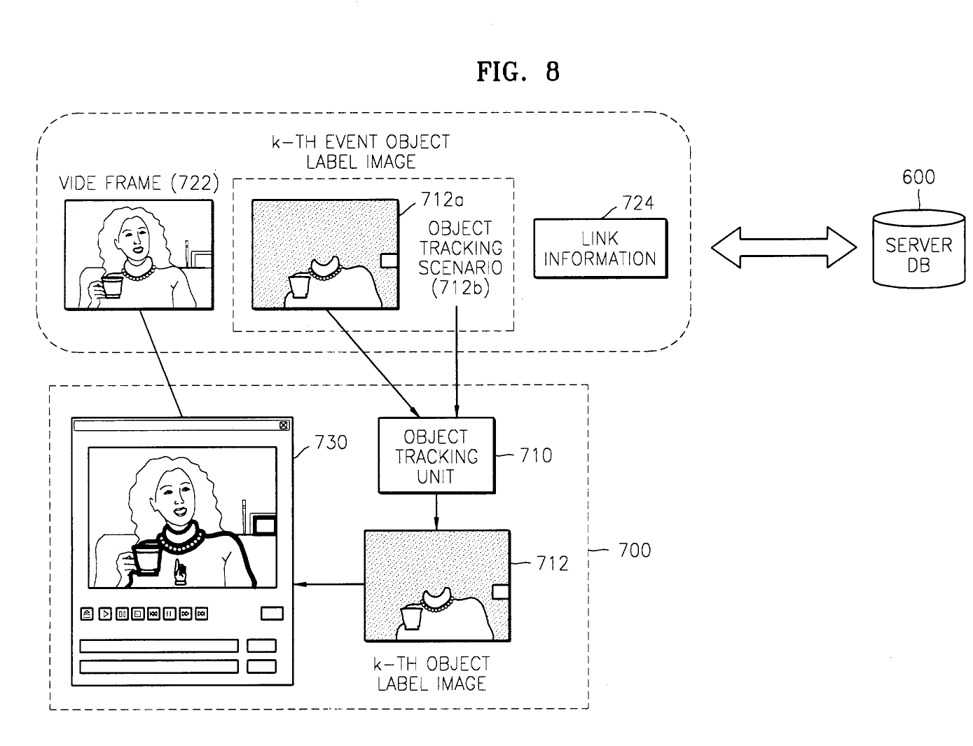

FIG. 8 is a diagram for explaining the operation of the client unit 700 when new object tracking scenario data due to the occurrence of an event are transmitted together. For example, if the service server 600 provides the tracking scenario data shown in FIGS. 5(a) through 5(d), when video frames are transmitted in frames N₀, N₁, N₂, and N₄ in which an event of tracking failure or new object appearing occurs, tracking scenarios 712a and 712b for corresponding objects and linked additional information 724 are transmitted together. In other frames, only frame data are transmitted.

Referring to FIG. 8, the interactive video reproducing unit 730 reproduces an event occurring frame 722 if the event occurring frame 722 from the service server 600 is received. Referring to tracking scenario data 712a and 712b and object label image corresponding to the previous frame, the object tracking unit 710 performs object tracking for each object, while generates and stores an object label image corresponding to a frame currently being reproduced.

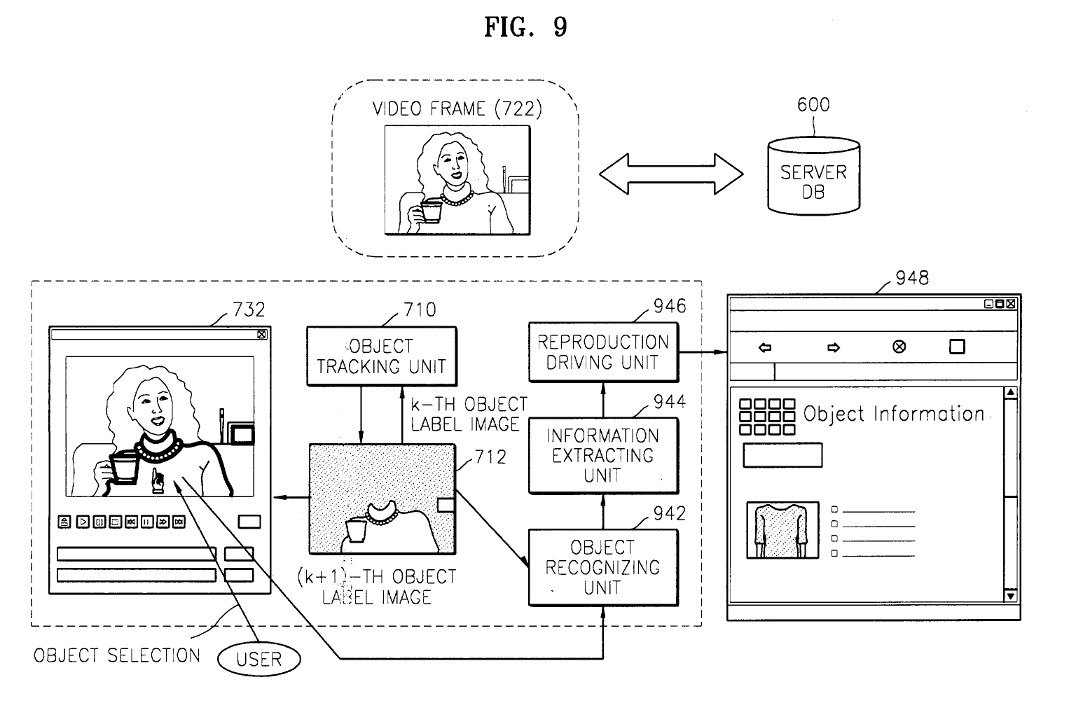

FIG. 9 is a diagram for explaining the operation of the client unit when event does not occur or when a user selects an object. In a frame in which an event does not occur, the service server 600 transmits only frame data to the client unit 700.

Referring to FIG. 9, the client unit 700 receives video frames from the service server 600, and reproduces the video frames through the interactive video reproducing unit 730. The object tracking unit 710 tracks each object according to the tracking scenario data received previously, while generates and stores in real time an object label image 712 corresponding to a frame currently being reproduced.

Meanwhile, the display unit 732 of the interactive video reproducing unit 730 reproduces the moving pictures stored in the memory unit 720 while providing interface with the user.

If the user selects a predetermined location through an input device such as a mouse, an object recognizing unit 942 refers to an object label image for each frame stored in the memory unit 720, maps the images with the pixel selected by the user, and recognizes the label of the object selected by the user.

An information extracting unit 944 extracts linked additional information corresponding to the object label recognized in the object recognizing unit 942, from the memory unit 720.

A reproduction driving unit 946 performs control so that the additional information extracted by the information extracting unit 944 is reproduced by the display unit 732. If the extracted additional information is a web page providing information on the selected object, the corresponding web page is made to be displayed as the screen 948 shown in FIG. 9.

The present invention may be embodied in a code, which can be read by a computer, on a computer readable recording medium. The computer readable recording medium includes all kinds of recording apparatuses on which computer readable data are stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can store and execute a computer readable code in a distributed mode.

Optimum embodiments have been explained above and are shown. However, the present invention is not restricted to the above-described embodiments and many variations are possible within the spirit and scope of the present invention. It is noted that the present invention is not limited to the preferred embodiment described above, and it is apparent that variations and modifications by those skilled in the art can be effected within the spirit and scope of the present invention defined in the appended claims. Therefore, the scope of the present invention is determined by the accompanying claims.

According the system and method for providing object-based video services of the present invention described above, the video authoring unit generates tracking scenario data that are for tracking processes of object areas instead of generating object label images corresponding to respective frames. Accordingly, since the service server stores only tracking scenario data taking up relatively less memory than object label images, memory use in the service server can be greatly reduced. Also, since the service server transmits only tracking scenario data whose amount is very small, transmission efficiency can increase while transmission error and data distortion can be minimized.

What is claimed is:

1. An object-based video service system comprising:
an interactive video authoring unit which tracks an object of interest for each frame of input moving pictures with using a predetermined object tracking algorithm, generates an object tracking scenario, and links each object to additional information;
a service server which stores the moving pictures, the object tracking scenario, and the additional information linked to each object, and if a service is requested through a communications network, provides the object tracking algorithm, the stored moving pictures, the object tracking scenario, and the additional information; and
a client unit which receives the object tracking algorithm from the service server through the communications network and installs the object tracking algorithm, and if the moving pictures, the object tracking scenario, and the additional information are provided, generates an object label image corresponding to each frame of the moving pictures according to the object tracking scenario by using the installed object tracking algorithm, extracts additional information corresponding to an object selected by a user based on the generated object label image, and displays the extracted additional information.

2. The object-based video service system of claim 1, wherein the interactive video authoring unit comprises:
an object tracking unit which performs object tracking for each object by using the object tracking algorithm, and stores initial object label images, in which the areas of interest objects are expressed in different gray values in a frame where an event occurs, parameters used in object tracking, and the result of object tracking;
a tracking scenario generating unit generates the object tracking scenario based on the initial object label images, the parameter values used in object tracking, and the result of object tracking; and
an additional information link unit which links related additional information to each object.

3. The object-based video service system of claim 1, wherein the client unit comprises:
a first memory unit which receives moving pictures from the service server and stores the moving pictures;
an object tracking unit which receives the object tracking scenario and the object tracking algorithm from the service server, and using the object tracking algorithm, generates in real time an object label image corresponding to each frame of the moving pictures, according to the object tracking scenario;
a second memory unit which stores the object label image for each frame generated in the object tracking unit;
a third memory unit which receives additional information linked to each object from the service server, and stores the received additional information; and
an interactive video reproducing unit which reproduces moving pictures stored in the first memory unit, referring to the object label image for each frame, recognizes an object selected by the user, extracts additional information corresponding to the recognized object from the third memory unit, and provides the extracted additional information.

4. An interactive video apparatus comprising:
a memory unit which receives moving pictures and additional information linked to each object that are transmitted through a communications network, and stores the moving pictures and the additional information;
an object tracking unit which if an object tracking scenario is transmitted through the communications network, drives a predetermined object tracking algorithm, generates in real time an object label image for each frame according to the object tracking scenario, and stores the generated object label image for each frame in the memory unit; and
an interactive video reproducing unit which reproduces the moving pictures stored in the memory unit, and referring to the object label image for each frame, recognizes an object selected by a user, extracts additional information on the recognized object from the memory unit, and provides the extracted additional information.

5. The interactive video apparatus of claim 4, wherein the object tracking unit receives the predetermined object tracking algorithm from an external server through the communications network.

6. The interactive video apparatus of claim 4, wherein the interactive video reproducing unit comprises:
a display unit which reproduces the moving pictures stored in the memory and provides interface with the user;
an object recognizing unit which referring to the object label image for each frame stored in the memory unit, recognizes the label of the object which is mapped with a pixel selected by the user;
an information extracting unit which referring to the memory unit, extracts additional information corresponding to the object label recognized in the object recognizing unit; and
a reproduction driving unit which performs control so that the additional information extracted in the information extracting unit is displayed on the display unit.

7. An object-based video service method in which object-based interactive moving pictures are provided to a client unit belonging to a user, the method comprising:
(a) tracking an object of interest in each frame of the moving pictures according to a predetermined object tracking algorithm, while generating and storing an object tracking scenario;
(b) linking additional information to be provided for each object, and storing the additional information;
(c) if a request of providing the moving picture from the client unit is received, providing object-based video data, including the moving pictures, the object tracking scenario, and the additional information;
(d) the client unit generating in real time an object label image corresponding to each frame of the moving pictures according to the object tracking scenario with using the object tracking algorithm; and
(e) based on the generated object label image, displaying additional information corresponding to an object selected by the user.

8. The object-based video service method of claim 7, wherein if the client unit requests to provide the object tracking algorithm, when the object-based video data are provided, the object tracking algorithm is provided together.

9. The object-based video service method of claim 7, wherein the step (a) comprises:
(a1) assigning an area for one or more object of interest in the first frame of the moving pictures;
(a2) performing object tracking for each object from the first frame, by applying an object tracking parameter for each interest object for tracking the interest object in the first frame to the object tracking algorithm;
(a3) if a predetermined event on an object occurs in a predetermined frame in the object tracking, applying a new object tracking parameter for tracking of the object to the object tracking algorithm, and performing again the tracking of the object from the frame in which the event occurred;
(a4) generating object label images corresponding to the frames in which events occur; and
(a5) generating an object tracking process as the object tracking scenario based on the object label images, the object tracking parameters for respective objects, and the result of object tracking.

10. The object-based interactive video service method of claim 9, wherein the steps (a3) and (a4) comprise:
(a31) generating and storing an object label image in which the areas of interest objects in the first frame are expressed in different gray values;
(a32) in a frame in which tracking of a predetermined object fails, after resetting an object area for the corresponding object, changing the corresponding object tracking parameter, and applying the changed object tracking parameter from the frame in which the tracking of the object failed, tracking the object;
(a33) generating an object label image corresponding to the reset object area;
(a34) in a frame in which a new object appears, after setting an object area for the corresponding object and a parameter for tracking the corresponding object, and applying the set parameter to the object tracking algorithm, tracking the new object from the frame in which the new object appeared; and
(a35) generating an object label image corresponding to the object area set in the step (a34).

11. A computer readable medium having embodied thereon a computer program for the object-based interactive video service method of claim 7.

12. An object-based video reproducing method in which object-based moving pictures are displayed on a display unit interfacing with a user, the method comprising:
(a) receiving moving pictures, an object tracking scenario on an object tracking process, and additional information linked to each object, from the outside, and storing the data in a memory;
(b) generating in real time an object label image corresponding to each frame of the moving pictures according to the object tracking scenario, by using an object tracking algorithm, and storing the object label images;
(c) reproducing the stored moving pictures, and recognizing an object selected by the user by referring to an object label image corresponding to each frame; and
(d) extracting additional information linked to the recognized object from the memory and providing the extracted additional information.

13. The object-based reproducing method of claim 12, wherein the object tracking algorithm is provided by an external server when there is a request.

14. The object-based reproducing method of claim 12, wherein the steps (c) and (d) comprises:
(c1) reproducing the stored moving pictures through the display unit and recognizing a pixel on a frame which is selected by the user to select an object;
(c2) recognizing the label of an object which is mapped with the pixel recognized in step (c1) by referring to the object label image for each frame; and
(c3) extracting additional information corresponding to the object label recognized in step (c2) from the memory and displaying the extracted additional information.

15. A computer readable medium having embodied thereon a computer program for the object-based interactive video reproducing method of claim 12
